(19) United States
(12) Patent Application Publication
(10) Pub. No.: US 2007/0103294 A1
(43) Pub. Date: May 10, 2007

(54) Critical incident response management systems and methods

(76) Inventors: Jona Bonecutter, Santa Fe, NM (US); Robert F. Hausman JR., Cerrillos, NM (US); David J. Bailey, Albuquerque, NM (US); Dennis Fecteau, Sausalito, CA (US)

Correspondence Address: VENABLE LLP, P.O. BOX 34385, WASHINGTON, DC, 20043-9998, US

(21) Appl. No.: 11/432,714

(22) Filed: May 12, 2006

Related U.S. Application Data
(60) Provisional application No. 60/782,275, filed on Mar. 15, 2006.
(60) Provisional application No. 60/731,755, filed on Oct. 28, 2005.

(51) Int. Cl. G08B 1/08; G06K 9/00; G08B 1/00

(52) U.S. Cl. 340/539.18; 340/531; 382/115

(57) ABSTRACT

Systems and methods may enable first incident responder management and support. System and methods enabled by software may utilize communications networks and location based systems such as the Global Positioning System (GPS) to locate the incident and response units, and to relay and share critical incident management information for use by other emergency response operators associated with an emergency scene. Maps and icons may be accessed and utilized over devices in the field. Software modules enable a system operator to use maps and a selection of user interface objects such as custom icons symbolizing a list of responders (police, fire, rescue, military) called forward and may designate specific geographic positions for managing a crisis.

### TECHNICAL FIELD OF INVENTION

The present invention is generally related to the field of emergency response management, coordination and communications technologies applied at the scene of an incident (e.g., hostage situation, catastrophe, ongoing crime, rescue operation). More particularly, the present invention is related to the application of a first incident response management system including systems and methods that may utilize wireless data communications networks, geographic information systems (GIS) mapping programs and location identification systems to relay and share critical incident management information with first responders to support their mission.

### BACKGROUND OF THE INVENTION

In recent years a number of high profile acts of violence and other crises have occurred all over the world gaining the attention of the media and large segments of the public. Confusion and disorganization are usually the initial reaction of people involved in a crisis, or they may suffer from shock. The situation is often made worse when unreasoned attempts are made to solve the crisis. A critical incident (e.g., hostage situation, catastrophe, ongoing crime, rescue operation) requires an immediate response that should be carried out calmly. Pre-planning for emergencies can speed reaction time, avoid trial-and-error solutions and reduce the amount of time needed to resolve the crisis. First responders such as military, law enforcement agencies and medical emergency response teams are frequently confronted with such situations. Current emergency response management systems are used to provide secure communications between an emergency response team members and remote control assets (e.g., emergency response command centers).

The first law enforcement officer at the scene of an emergency is generally designated the manager of the scene and must begin to act immediately as a first responder. Oftentimes, the officer only has two-way radio communications to direct other operators at the scene. Some officers may utilize a map of the area of operation and pens/pencils to mark where key personnel and equipment should be located at the scene. Unfortunately, the lack of specific location information and multiple responders in the field (e.g., police, fire, emergency, SWAT) can cause confusion at the scene. Furthermore, as the scene changes, so does writing on a map when used, which can add to the confusion. Hence better tools are needed in the field of emergency response management for first responders to coordinate emergency efforts.

Some systems and methods have been developed in the recent past to help manage an emergency incident from a single command center. An emergency incident system capable of providing projected results and effects based upon varying the input data as a function of the consequences of presently made or proposed decisions by the decision makers is described in U.S. Pat. No. 5,815,417 “Method for acquiring and presenting data relevant to an emergency incident” by Orr et al. In Ore et al., data collected from a plurality of sources are converted into an electronic database which may be automatically and/or periodically updated during the course of the emergency incident and a series of software modules associated with the database utilizes this data for a series of specific applications to reduce the public risk. The output provided by modeling and simulation modules may be in the form of two-dimensional or three-dimensional visual presentations in specially equipped multiple, computer-driven screens in a command center.

What is needed in the field of emergency response management is technology that enables a first responder who is designated the manager of a critical incident, because of the status as “first to arrive at a scene”, to better manage an emergency situation directly in the field using, for example, computer and communications (including wireless) network technology and to share accurate, real-time information with other responders supporting the incident. These and further features and advantages are accomplished by the present invention with the provision of systems and methods taught herein.

### SUMMARY

It is a feature of exemplary embodiments of the present invention to provide systems and methods enabling first responders to better manage an emergency situation directly in the field using computer and communication network technology and to share accurate, real-time information with other responders associated with and supporting an emergency incident.

According to exemplary aspects of the present invention, systems and methods are described that may enable multiple responders at or near an emergency scene to utilize networks including wireless computers to retrieve information published by the manager in order to view the section of a geographical area where the incident has occurred via geographic information systems (GIS) such as, e.g., but not limited to, computer generated mapping programs

According to exemplary aspects of the present invention, the first responder (1R) and collaborating responders at the scene may be enabled to manipulate the GIS, such as, e.g., but not limited to, zoom in and out and pan to a desired street or overall view of the area and any georeferenced data representing its surroundings wherein resources can be or are allocated

According to exemplary aspects of the present invention, it is also desirable to enable and facilitate asset tracking at the scene using wireless devices and geosynchronous positioning system (GPS) and/or other location based and/or georeferenced information

According to exemplary features of the present invention, an emergency incident management system may include wireless devices and software modules that may utilize the internet and global positioning satellites to relay and share (e.g., publish) critical incident management information for other law enforcement and emergency personal for use while conducting operations at an emergency scene.

According to exemplary features of the present invention, the invention may utilize a combination of computer generated maps, GIS application programming interface (API) tools, icons via, e.g., but not limited to, hand held personal digital assistant (PDA) and/or laptop computer and/or communication devices to facilitate emergency management.

According to exemplary features of embodiments of the present invention, software modules operable on portable devices can enable a first responder designated the manager of a critical incident (“critical incident manager”) to access and view the geographic area (e.g., section of the city) wherein an incident has occurred or is occurring via a GIS and/or mapping program (such as, e.g., but not limited to MapQuest™ provided by MapQuest, Inc., or MapPoint™ provided by Microsoft Corporation, Argus, ESRI, Map Info or similar mapping software systems), thus allowing the manager to e.g., but not limited to, manipulate, view, pan, and/or zoom in and out of an electronic map to a desired street or overall view of the area and its surroundings wherein the resources can be allocated.

In accordance with exemplary features of embodiments of the invention, software modules enable hand held systems to provide the manager with a selection of tools such as, e.g., but not limited to, custom icons symbolizing, e.g., the list of persons the manager requests and designates to specific positions for securing perimeters, enlisting security and enlisting rescue personnel.

In accordance with exemplary features of the invention, a first responder/manager can publish commands (e.g., such as having police units block off specific streets) to support personnel by graphically and/or visually selecting icons representing response resources, and dragging and placing the icons onto specific areas on an electronic map. Alternatively, objects may be automatically inserted by, e.g., but not limited to, software agents, location identification modules, etc. The manager, in an exemplary embodiment, can continue to update and generate new views (publications) of a scene by moving or placing icons on the computer generated map in the specific areas needed to manage the scene (e.g., but not limited to, designating the hot zone by one or more perimeter lines and/or circles). In an exemplary embodiment, computer screens can be automatically updated (published) with each new icon placement, allowing all responders at a scene and other interested parties to view the positioning of assets at and around the scene. An incident may be recorded and/or stored including temporal time stamps to allow later playback and/or review. Snapshots of the incident may be taken at different times and stored, for example, on a periodic basis, after user actions, etc.

In an exemplary embodiment, accurate emergency situation management may help field operators (e.g., police and emergency medical personnel) avoid entering hazardous areas (e.g., hot zones) and endangering themselves. The map may, for example, also illustrate the location of the temporary command post (which can be shown as an icon), or how an ambulance can safely be routed through the scene and be placed close enough to rescue, and so on.

In an exemplary embodiment, the first responder on scene can graphically indicate, view and visually manage an operation in what can be regarded as a “game board”-like layout using portable computers having wireless data communications capabilities. Embodiments of the present invention may allow the first responder officer to be free of cumbersome maps, pens and stickers now used to keep track of commands, and the ability to share visually, rather than only verbal information to fellow responders within a split second. The first responder on scene may, with this system, indicate a plan to secure the area, limit access to the scene, utilize law enforcement and emergency personal intelligently, re-route traffic and civilians, limit crowd size, and share the responder's decisions and commands visually and quickly. Information may be depicted graphically in at least 2 dimensions, 3D, or more. Georeferenced data sources may be selectively incorporated including, e.g., but not limited to, buildings, individuals, vehicles, streets, jurisdictions, satellite imagery, real time location based data, etc.

In accordance with yet another exemplary aspect of the invention, detailed information (such as, e.g., but not limited to, floor plans) can be retrieved, georeferenced, managed and/or published for various structures such as, specific city state and government buildings to include, e.g., all schools, in a digital format, with a detailed interior and exterior layout of these buildings, so that, for instance, if there was a shooter in a school, an overhead interior layout of the school may be displayed so that officers and S.W.A.T. teams can see the rooms and hallways etc. and navigate the scene with immediate, visual intelligence of the interior.

Embodiments of the invention provide a graphical, map-oriented visualization of the incident environs scaled to facilitate the functions that a responder may perform that may be implemented on a laptop computer installed in the responder's unit, or other internet device. A set of software buttons or other mechanisms that indicate to the responder the specific tasks that may be performed in the initial minutes of the incident response color coded to visually indicate to the first responder (and to other responders) whether the tasks have been completed. A set of icons specifically representing first responders and or other graphic indicators that instantly show the location of the incident command post, the hot or hot zone, the inner and outer perimeters, staging areas for the public and press and fire and medical personnel may be included. Embodiments of the invention provide an extremely simple method for locating responding units and staging areas on the map and showing their status, so that all units have immediate understanding of the status of the incident response.

Embodiments of the invention may also provide a method for recording all incident related activity along with one or more timestamps, and a method for reporting incident activity to a central server where it can be stored and re-displayed for other involved parties such as dispatchers and commanders. Further embodiments provide a method for pre-planning events requiring deployment of department resources and then using the plan as a template for the actual deployment when the event occurs. Further embodiments provide a method for using templates as a mechanism for training new officers at the academy to augment or replace tabletop exercises. The server may provide a mechanism for turning a closed incident into a template so that it can be used in a training situation.

Embodiments of the server may provide for publication of a web page to a separate web server that can be viewed by other authorized personnel (such as non-responding commanders, local government officials, other agency officials, or state and national officials. The application server may be designed to simultaneously support many incidents being handled by many agencies. It may implement several classes of users with different access privileges, and it may support federation of differing agencies in which each agency agrees to trust a user authentication offered by another federated agency. This mechanism allows for mutual cooperation without having to maintain a single large, hard to administer access control database.

Embodiments of the server may accept input data (event data) from some remote devices in the field at or near the location of the incident. In its totality, the input data may constitute a history of the incident management events created by the incident commander and the dispatcher. Other responding units can read this history in order to establish a current view of the incident, but other responding units may not be able to add to the event data because access controls only allow the incident commander or the dispatcher to create event data. No client is allowed to delete any event data. Thus, when the incident is closed, a complete history of the events that occurred while responding to the incident is preserved. This history is separate from error and performance logs that are also being kept for all clients and for the server.

An embodiment of the invention may contain a server complex, which may consist of an application server, a web server, a database server, and a certificate authority. These services may be provided on multiple computers protected by firewalls and may include other services such as high-availability configuration, load-balancers, and other infrastructure services. An embodiment of the invention may contain a plurality of server complexes configured so that they can provide mutual backup and so that they can intervene to capture an incident in progress in the event that a server might fail.

In an embodiment of the invention, individual servers could serve multiple departments or agencies. For example, a server being used by the Albuquerque Police Department (APD) might also serve the Albuquerque Fire Department (AFD) and the Tuscon Police Department (TPD). Each of these agencies could have several incidents in progress at the same time, and the server may creating an event data history of each incident and keep them all separate. Further embodiments of the server may support cooperative agreements between agencies that would allow for cooperative response to a single incident in which all responding parties would be able to see the same view of the incident showing response units from more than one agency. Other agencies not a party to the cooperative agreement (e.g. TPD not a party to an agreement between APD and AFD) would not be able to view the incident event data.

### BRIEF DESCRIPTION OF THE DRAWINGS

Features, aspects and advantages of the present invention will become better understood with regard to the following description, appended claims, and accompanying drawings where:

FIG. 1 illustrates an exemplary embodiment of a block diagram including the basic components of a first incident response support system and methods in accordance with an exemplary embodiment of the present invention.

FIG. 2 illustrates an exemplary embodiment of a flow diagram of method and steps undertaken as personnel are dispatched to a scene in accordance with the aspects of the present invention.

FIG. 3 illustrates an exemplary embodiment of a flow diagram of method and steps undertaken for identifying the first responder (1R) with respect to the department affiliation and to establish a secure channel for communication.

FIG. 4 illustrates an exemplary embodiment of a flow diagram of methods and steps undertaken by the first responder (1R) to access maps of an incident location by utilizing the icons to populate the map with relevant scenario information.

FIG. 5 illustrates an exemplary embodiment of a flow diagram of the methods, steps undertaken by the first responder (1R) to retrieve additional information about a participant or landmark by selecting the icon associated with the participant or landmark.

FIG. 6 illustrates an exemplary system according to an embodiment of the invention.

FIG. 7 illustrates another exemplary system according to an embodiment of the invention.

FIG. 8 illustrates an exemplary embodiment of an exemplary screen shot of what might be shown when the first responder (1R) first opens the software program and initiates a new incident.

FIG. 9 illustrates a graphical user interface according to an exemplary embodiment of the invention.

FIG. 10 illustrates a graphical user interface showing a zoomed in view according to an exemplary embodiment of the invention.

FIG. 11 illustrates a graphical user interface showing user interface icons according to an exemplary embodiment of the invention.

FIG. 12 illustrates a graphical user interface showing perimeters according to an exemplary embodiment of the invention.

FIG. 13 illustrates a graphical user interface showing additional requested unit types, staging areas, and agencies according to an exemplary embodiment of the invention.

### DETAILED DESCRIPTION OF THE INVENTION

The particular values and configurations discussed in these non-limiting examples can be varied and are cited merely to illustrate embodiments of the present invention and are not intended to limit the scope of the invention.

A “computer” refers to any apparatus that is capable of accepting a structured input, processing the structured input according to prescribed rules, and producing results of the processing as output. Examples of a computer include a computer; a general-purpose computer; a supercomputer; a mainframe; a super mini-computer; a mini-computer; a workstation; a microcomputer; a processor; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” refers to any storage device used for storing data accessible by a computer. Examples of a computer-readable medium include a magnetic hard disk; a floppy disk; an optical disk, like a CD-ROM or a DVD; a magnetic tape; a memory chip (e.g., ROM or RAM); and a carrier wave used to carry computer-readable electronic data, such as those used in transmitting and receiving e-mail or in accessing a network.

“Software” refers to prescribed rules to operate a computer. Examples of software include software; code segments; instructions; computer programs; and programmed logic.

A “computer system” refers to a system having a computer, where the computer comprises a computer-readable medium embodying software to operate the computer.

An exemplary embodiment of the system may support communications networks such as, e.g., but not limited to, Local Area Network (LAN), Wide Area Network (WAN), Metropolitan Area Network (MAN), and Mobile Autonomous NETwork (MANET) architectures including wired and wireless networks. Owing largely to the advances and publicity surrounding Global Positioning Systems (GPS) and wireless data communications networks, personal/emergency location systems can be considered widespread. Advances in wireless and mobile technology, wireless data network infrastructure and the pervasiveness of wireless communications, are now at a technological state wherein they may be used in a straight-forward and innovative approach in situations where distress and tragedy must be managed.

Embodiments of the invention provide systems and methods for emergency response management. Embodiments of the invention provide a system and method to dynamically manage an incident, such as an emergency situation. An incident response plan may be dynamically created at any location on an ad hoc basis. A view of the incident location, such as a map of the incident area, may be published to a user, for example via a graphical user interface on a mobile computer. The map may be published based on a selection by the user that is received via a user interface displayed on the mobile computer. Information regarding the incident may be dynamically created by the user using the mobile computer and associated software, received from the mobile computer and shared with other users.

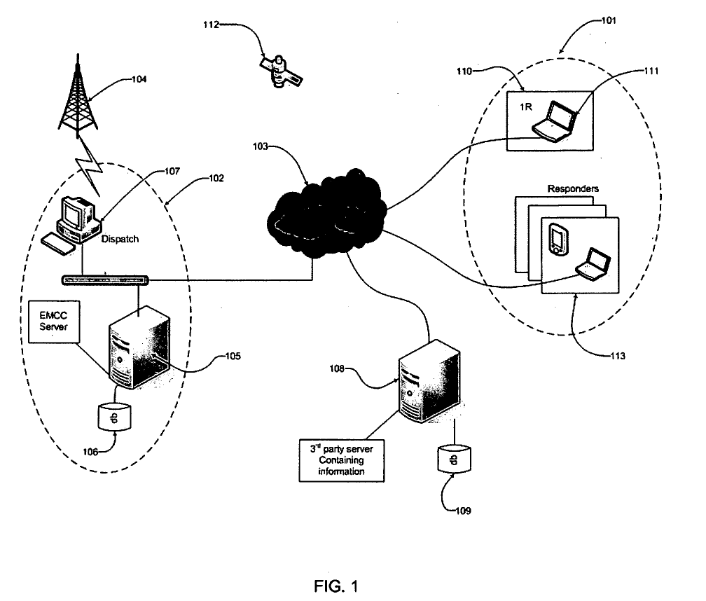

Referring to FIG. 1, a block diagram 100 is illustrated showing an exemplary embodiment of the basic components of a first incident response support system and methods in accordance with an exemplary embodiment of the present invention. During an incident, some personnel and equipment are located at the incident 101, and other personnel and equipment are at the emergency management command center 102. An emergency management command center (EMCC) server 105 may manage and maintain data in a database 106 about first responders, support, collaborating departments, and capabilities of participating third parties 108. The EMCC server 105 may be coupled or connected to a network 103 to enable access by field units (first responders or others via a web or other network interface and other authorized field participants) as well as dispatch personnel. A dispatcher 107 may dispatch at least one officer (1R 110 and additional resources) to a scene of an incident 101 using, e.g., but not limited to, a radio channel 104. Dispatch may occur over a communications network such as, e.g., a High Frequency (HF) radio. The first officer (1R) 110 to the scene may be designated the scene commander. The 1R 110 may coordinate all efforts at the incident scene utilizing a portable device 111 (co-located with 1R), which may possibly have network access. In addition or instead of the 1R being designated the scene commander, the dispatcher 107 or others may also be allowed to coordinate efforts at the incident scene. In the case of multiple users being permitted to enter data regarding the incident, a conflict resolution mechanism may be provided.

The portable device 111 may typically be, e.g., but not limited to, a laptop computer mounted in a vehicle, but may also be a PDA, smart phone, etc. or other computing and/or communications device. The 1R 110 may receive information from the EMCC (Emergency management command center server) 105, dispatch/CP 107 and also third party servers 108 having a database of information about the scene of the incident or third party participant capabilities 109. For example, the 1R may retrieve building schematics from city/county records, or information regarding the capabilities of a local expert (e.g., physiologist, MD, terrorism expert, medical centers). Information may be typically stored in a database 109, which may be accessible through the third party server 108. Location information such as, e.g., GPS satellite position 112 data can be used to enable the system to automatically determine 1R 110 and participant 113 location on a map, or can be used to find the incident. Wireless communication may be supported by communications equipment such as, e.g., but not limited to, HF radio towers 104 providing wireless voice or data communications between responders 110 and dispatch 107.

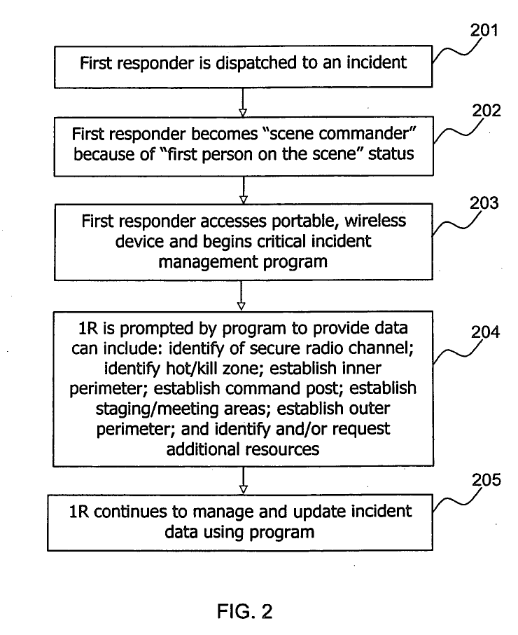

Referring to FIG. 2, a flow diagram 200 of exemplary method steps that can be undertaken as personnel are dispatched to a scene is shown. As shown in step 201, the first responder may be dispatched to the scene of an incident. As shown in step 202, the first responder (1R) may become the “scene commander” because of “first person on the scene” status 202. The 1R 110 may access a portable, wireless device 111 and may begin a critical incident management (CIM) program as shown in step 203 to assist the 1R in managing the incident. As shown in step 204, the 1R 110 may use the CIM program to provide data about the incident, which can include, in an exemplary embodiment: identifying a secure radio channel for use by participants; identifying a hot or hot zone (depending on if the incident is an ongoing crime or a Hazmat, accident or natural emergency); establishing an inner perimeter for the operation; establishing a command post; establishing a staging/meeting area for participants (decision makers); establishing an outer (or additional) perimeter; and identifying and/or requesting addition resources as necessary to support the incident. Then, as shown in step 205, the 1R may continue to use the program to manage the scene and update information or requests.

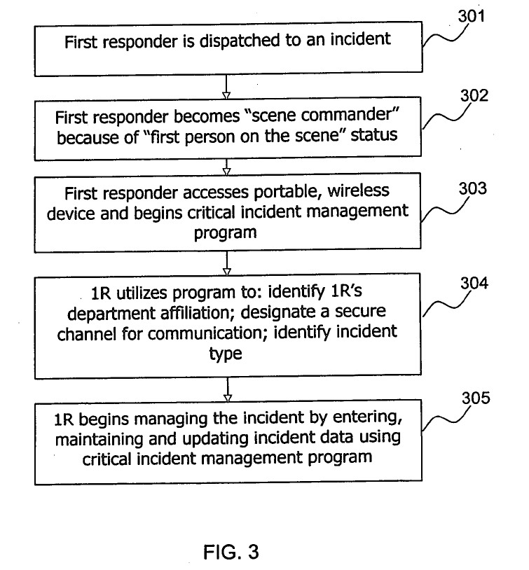

Referring to FIG. 3, a flow chart 300 outlining an exemplary embodiment of a method, steps that may be undertaken for identifying the first responder (1R) 110 with respect to the department affiliation and to secure one or more channels for communication are shown. As shown in step 301, the first responder is first to the incident where the incident has taken place. Then the first responder may become the scene commander on the scene status as shown in step 302. The first responder may access a portable, wireless device 111 and may begin the CIM program as shown in step 303 by enabling software modules. As shown in step 304, the 1R can utilize the software modules to identify the IR's department affiliation, and may designate a secure channel for communication. The 1R may further identify the type of incident. Then, as shown in step 305, the 1R may begin managing the incident by, e.g., but not limited to, entering, maintaining and/or updating incident data using the CIM program.

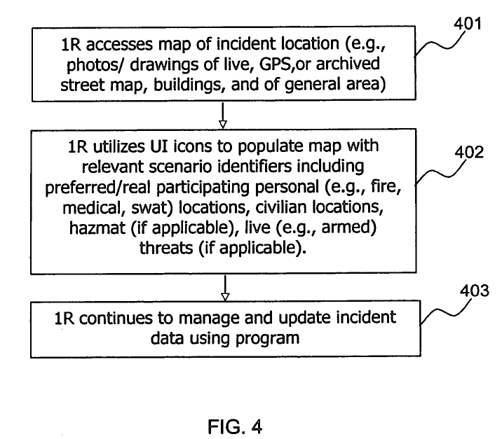

Referring to, FIG. 4 a flow chart 400 outlines the method steps that may be undertaken, in an exemplary embodiment, by the first responder (1R) to access information regarding an incident location, such as maps of the incident location, by utilizing user interface (UI) icons and to populate the map with relevant scenario information. As shown in step 401, the 1R 110 may access a geographical information system (GIS) which may include, in an exemplary embodiment, a map of the incident location (e.g., photos/drawings of the live scene, GPS or archived street map, buildings, and the general area). Next, as shown in step 402, the 1R may utilize user interface (UI) icons to populate the map with relevant scenario identifiers including, e.g., but not limited to, preferred/real participating personal (e.g., fire, medical, swat) locations, civilian locations, hazmat (if applicable), live (e.g., armed) threats (if applicable) 402. Then the 1R may continue to manage and update incident data using the program as shown in step 403. Temporal time stamps may be captured and stored along with the then current state of information regarding the incident. The state of the incident may be saved in a database after each action taken by the 1R or other system user. The state information may then be stored along with the time stamp. The state information may also be stored on a periodic or other time basis, for example every 30 seconds. The state information and time stamp may be saved to allow for storage, review, and/or playback of an incident. This may be useful for training, incident response review, evidence, etc.

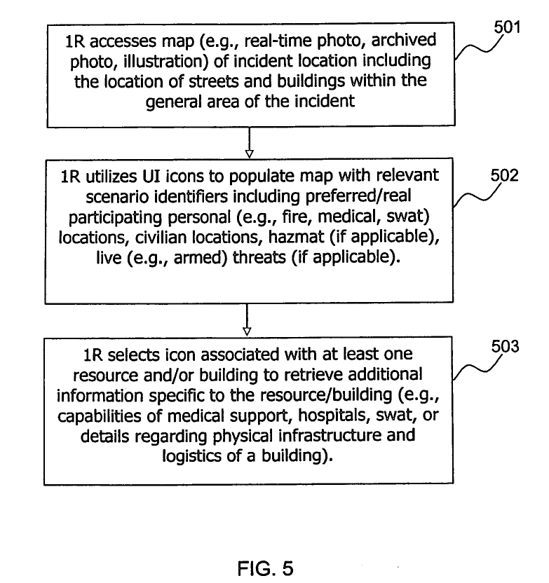

Referring to FIG. 5, a flow chart 500 is shown outlining a method of an exemplary embodiment, which may include, steps that can be undertaken by the first responder (1R) to retrieve additional information about a participant or landmark by selecting the UI icon associated with the participant or landmark is illustrated. The 1R may access georeferenced data which may be in the form of a 2D, 3D, or nD map (e.g., real-time photo, archived photo, illustration) of the incident location, including the location of streets and buildings within the general area of the incident as shown in step 501. Then the 1R may utilize UI icons to populate the map with relevant scenario identifiers including preferred/real participating personal (e.g., fire, medical, swat) locations, civilian locations, hazmat (if applicable), live (e.g., armed) threats (if applicable), etc. as shown in step 502. As shown in step 503, the 1R may select an UI icon associated with at least one resource and/or building to retrieve additional information specific to that resource/building (e.g., capabilities of medical support, hospitals, swat, or details regarding physical infrastructure and logistics of a building).

The CIM program may be embodied as software running on one or more computers. The computers may be configured in a client/server architecture. The software may provide nearly instantaneous, continuing status information, for example, to dispatch, senior management, other government officials, and, when desired, press and public. Incident history and data may be provided to incident management systems used for longer lasting incidents. The capability of replaying incidents to be used as training scenarios and for after-action analysis of the handling of an incident may also be supported.

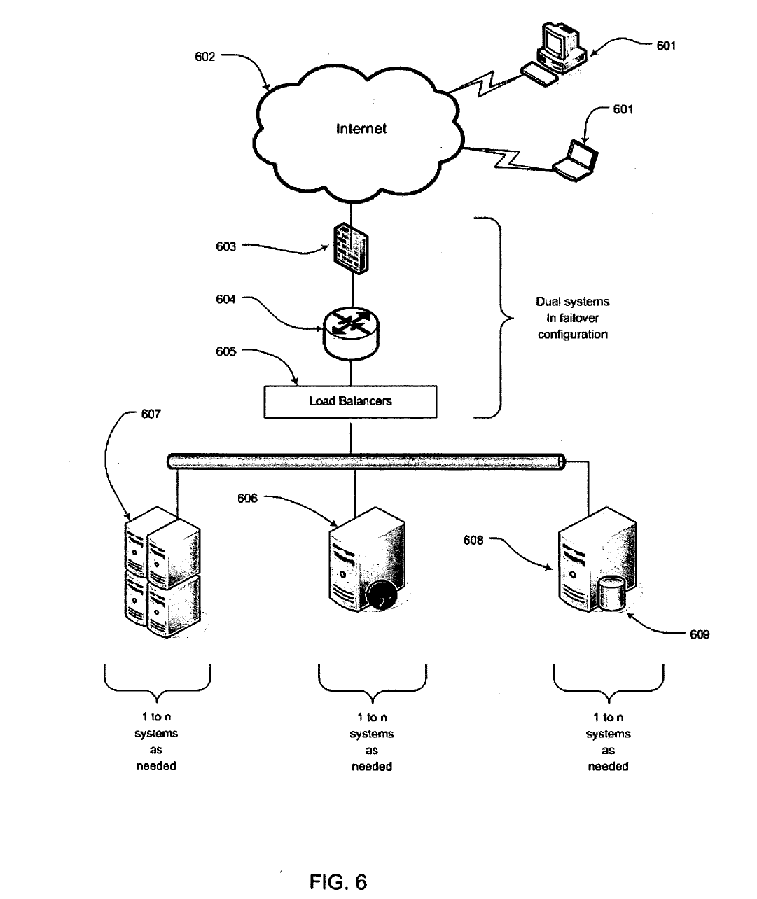

Referring again to the drawings, there is shown in FIG. 6 a schematic diagram of a system 600 comprised of components 603-609 that provides critical incident management according embodiments to the present invention.

System 600 is intended to be accessed by a plurality of clients 601 such as portable device 111 (FIG. 1). Such clients 601, in turn, suitably comprise one or more conventional personal computers and workstations. It should be understood, nevertheless, that other clients 601 such as Web-enabled hand-held devices (e.g., the Palm V™ organizer manufactured by Palm, Inc., Santa Clara, Calif. U.S.A., Windows CE devices, and “smart” phones) which use the wireless access protocol, and Internet appliances fall within the spirit and scope of the present invention.

Clients 601 of all of the above types suitably access system 600 by way of the Internet 602. By use of the term “Internet”, it should be understood that the foregoing is not intended to limit the present invention to a network also known as the World Wide Web. It includes intranets, extranets, Virtual Private Networks (VPNs), and the like.

Clients are directed to the service provider's web servers through firewall 603, routers and proxy servers 604 and load balancer 605. Each of the web server 606₁, 606₂, . . . 606ₙ is, in turn, preferably comprised of a HP LH3R NetServer (manufactured by Hewlett-PackardCorporation) or similar system. Preferably, each of the web servers 606₁, 606₂, . . . 606ₙ further comprises a Microsoft® Windows® Server 2003 operating system or similar system, or Netscape Enterprise Server, Release 3.6.3 (developed by Netscape Communications, a subsidiary of America Online, Inc., Dulles, Va. U.S.A.) or other similar system. Additionally, an X.500 and X.400 capable PKI (Public Key Infrastructure) like Entrust, VeriSign, or RSA may also be installed to facilitate digital certificate storage, issuance, and management services, as well as distribution of certificates and certificate-revocation lists to clients and other servers. Digital certificate management may be privately managed or provided by a third party certificate server. Other forms of certificate servers (e.g., web certificate servers and wireless certificate servers, which are available from VeriSign, Inc., Mountain View, Calif. U.S.A.) may likewise be deployed on each of the web servers 606₁, 606₂, . . . 606ₙ.

System 600 further comprises a plurality of application servers 607₁, 607₂, . . . 607ₙ, coupled to and providing support to the web servers 606₁, 606₂, . . 606ₙ. Each of the application servers 607₁, 607₂, . . . 607ₙ is, like the web servers 606₁, 606₂, . . . 606ₙ, preferably comprised of a HP LH3R NetServer. System 600 further comprises a plurality of databases 608₁, 608₂, . . . 608ₙ, coupled to the application servers, preferably comprised of HP LH3R NetServers or similar systems using Oracle or another high-performance database system. High availability storage 609 for the database 608 is also provided and preferably is a Raid 5 Shared Storage.

The entire Critical Incident Management (CIM) system comprises a plurality of systems 600 located in different parts of the world and all connected to each other via the Internet 602. This configuration facilitates backup in the event of server failures and provides rapid service to local agencies. The configuration also facilitates cooperation between agencies. Each client 601 may have a preferred server 607, available somewhere in the network. When a network connection is available, the client 601 may transmit updates to its preferred server 607 as the incident moves forward. If the network connection is not available, the data, which may always be retained on the client 601, may be retained at the client 601 until a connection is again available. This activity may occur independently from the operation of the client software. The incident could be at any state when the network becomes available, and the server 607 may be updated to the current status. The client 601 may operate despite the lack of a network connect, without a reduction in the effectiveness of the client. Lack of a connection simply means that observers may be unable to get incident status information from the web server 606.

Whenever a user makes a change in incident information using the CIM program, such as requesting an additional unit at a specific location, the request may be made as is typically done today without the use of the CIM program to the dispatcher 107. Utilizing the CIM program, the user may use a graphical user interface to move an appropriate icon to the requested location, as is described in more detail below. The request may recorded in a local client's log and transmitted to the application server 607. The application server 607 may then modify the incident currently being displayed, create a new html page, and send it to the web servers 606. Also, the application server may receive location information from location based systems in responders vehicles or at other locations and automatically update the incident information, without the need for user input. The web server 606 may display active web pages to authorized users, so each time a page update is requested by a browser, the changed status may be displayed. All changes transmitted by client systems 601 to the application server(s) 607 may be preserved by the database server(s) 608 using a high-availability storage system 609.

A dedicated server may be provided for different localities, states, countries, etc. For example, a local, dedicated server may be provided for police, fire departments and the like in a particular locality. Information regarding incidents in the respective localities is managed and stored by the local server and associated data stores. The local servers and data stores may be connected together as part of a larger network. Information from each of the local servers may be gathered and analyzed.

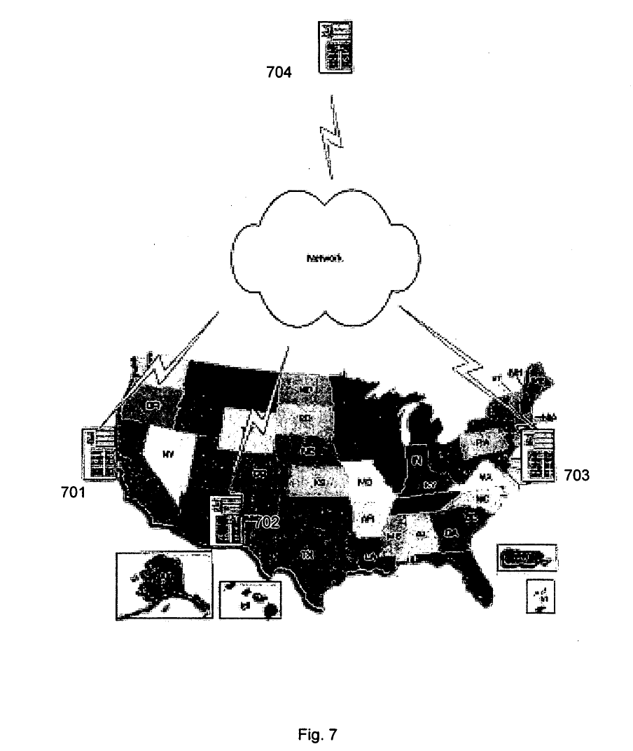

For example, as shown in FIG. 7, the San Francisco Police Department may use preferred server 701, the Albuquerque Police department may utilize preferred server 702, and the New York Police Department may utilize a preferred server 703. Each server 701-703 may communicate with server 704 via a network. Information regarding ongoing or past incidents from each of the servers 701-703 may be analyzed together, compared with each other, etc. by server 704, or any of the servers This capability may be used to detect patterns of activity or to manage crises that develop at multiple locations or at a state wide level, national level, international level, etc. For example, the Department of Homeland Security is responsible for national security. Information from individual localities when viewed in a vacuum may not be provide useful intelligence. However, when information from a number of localities is viewed together, a different picture may emerge. National patterns of activity may be detected. Also, an incident that plays out on a national level, such as September 11, can be managed. Information from the first responders at various incident scenes may be viewed by individuals, all the way up to the President, on a near real time basis, providing an invaluable tool for managing national critical incidents. Server 704 may be receive information from servers 701-703 and analyze that data. Client devices coupled to server 704 may view information and may even be given permission to enter information regarding incident being managed via one of the other servers, and vis versa.

Embodiments of the invention also allow for managing incidents on an international level. Clients, servers or both may be located in different countries. Interpol, the United Nations and other international organizations may share information using the disclosed systems and methods. Military organizations, such as NATO, the U.S. Army and the like may also share information and manage incidents using the disclosed systems and methods. Other uses will be apparent to one of ordinary skill in the art.

In embodiments of the invention, only certain users may be allowed to enter or change data regarding an incident. Other users may simply be allowed to view the information. Accordingly, different classes of users having different permissions may be provided. Exemplary classes of users include:

First responder—the officer assigned to respond and manage the incident;

Responders—using the client, responders can see the scene as the first responder sees it, but they cannot make changes or additions;

Dispatchers—using the client, dispatchers may create an incident, assign units to perimeter locations, or make other changes to an incident display in accordance with departmental doctrine. This capability may allow dispatchers to recreate the incident as seen by the 1R 110 even if the network connection is unavailable;

Department—departmental users and other authorized government users such as the mayor or the governor may access the incident via a web site, described below, which provides a graphic display similar to that provided by the client; and

Press/Public—the press and public may get a graphic display showing the location of the incident, the outer perimeter, and the staging areas. This display may or may not show unit deployments. The display may include additional information of specific interest to the press such as contact information for the public information officer.

Other or additional classes of users may be provided, depending on the specific implementation. A website may be created for the incident data. To access the website, a user may input a URL specific to the department or agency, into their web browser. An authentication may be performed before displaying the page that identifies and authenticates the user and also allows the software to determine to which access class the user belongs. A list of on-going incidents may then displayed allowing the user to select the incident of choice. For example, clicking a “Go” button may send the user to one of two different URLs depending on the user's access authorization. The page displayed may auto-refresh periodically so that the user sees the status of the incident being updated on the screen.

Viewers (other responders, dispatch, management, etc.) may also need to be able to easily find the incident of interest in the database of incidents maintained by the server. To do this, a viewer with a client may indicate that an incident is to be viewed instead of initiated. The client may then present a list of on-going incidents from which to choose. The list may include the starting time, approximate location, and the descriptive text entered when the incident was initiated.

A web viewer of the incident may need to supply some additional information in order to access the web view of the incident. Since the viewer may be accessing the incident from a server that supports a number of departments, a department code may need to be supplied. This information may be built into the URL sent to the server, and the URL may be obtained from a list of favorites.

The user may also have to be authenticated because different views are available to different types of users. For frequent users, such as dispatch 107, this authentication can be handled using certificates. Infrequent users may have to go through a separate authentication step. After the authentication, however it is accomplished, the user may be presented with the list of incidents available to that class of user. The list may appear the same as the list shown to responders with a client, but the content might be different because some incidents may not be available to all classes of users.

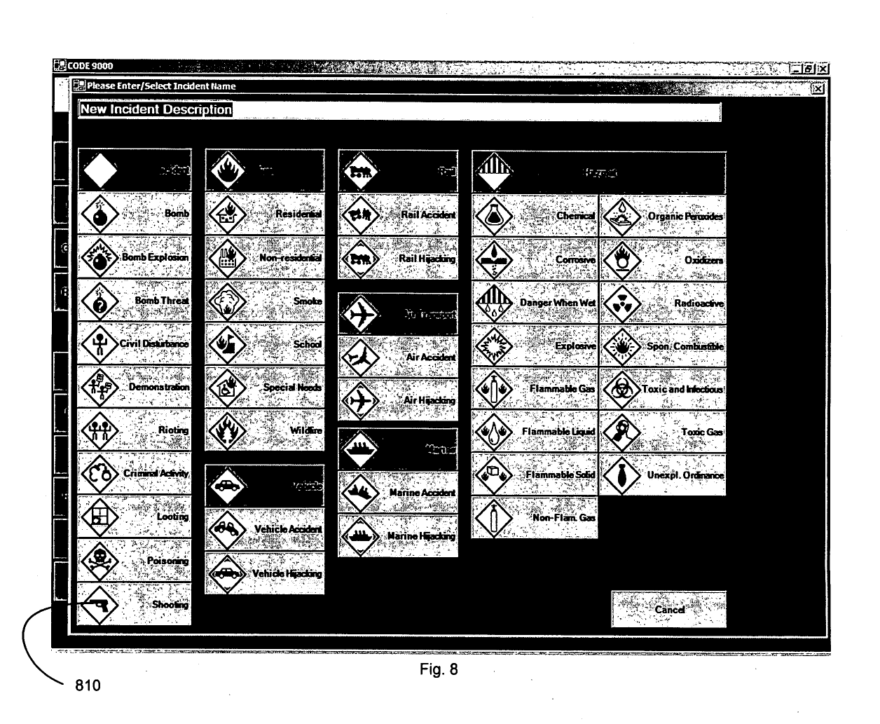

Referring to FIG. 8 a screen shot 800 illustrates an exemplary embodiment of what might be shown when a 1R first opens a software program supporting critical incident management and initiates a new incident. The software program may reside on mobile device 111 or be housed on a server, such as server 105. A GUI is presented to the 1R Using the GUI, the 1R may indicate a plurality of hazards present in the incident to which the 1R is responding. An icon associated with a selected incident type may then be shown in the main GUI window. In the following example, a shooting has been selected as the incident type, and the shooting icon 810 appears in the main window. The graphic icons associated with various incident types may be selected as a part of configuring a specific installation of the system.

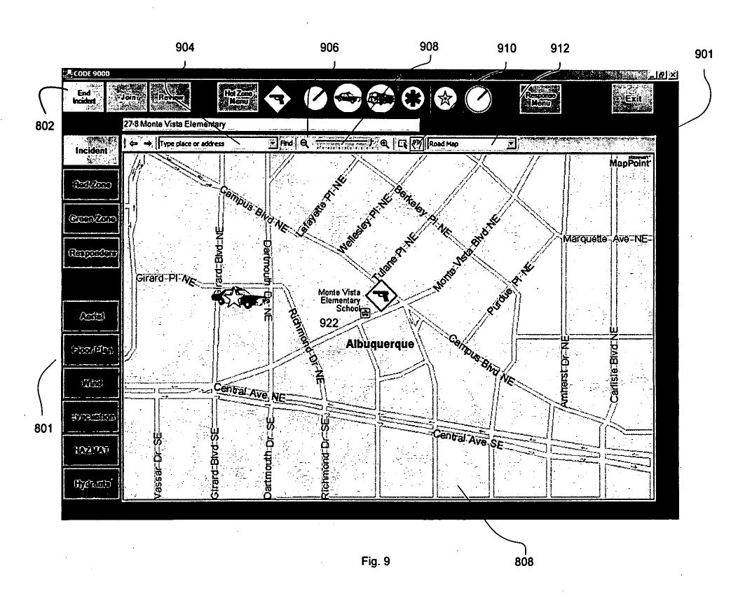

Referring to FIG. 9, another screen shot 801 illustrates an exemplary map portion 808 of the software. The map 808 may be at least a 2D map, with 3D, 4D (temporal), through n-D maps with additional data sources also possible. The map may initially show an area at a high level of abstraction. For example, depending on a particular implementation, an area may be shown at a country level, a state level, a city level, a county level, street level, etc. The user may then select the incident scene via device 111. This may be done using, for example, a touch screen, computer mouse, keyboard, pen-based interface or any other input device. In this example, the user may touch an area of a screen of device 111 and the CIM program may update the display with a zoomed in view of the map. The map may initially show a city level view of an area surrounding Albuquerque, N. Mex. By tapping the screen or clicking the mouse the user zooms in on an area of the incident, shown in Map 808. Several levels of zoom may be provided between views. As the incident develops, several icons may be placed on the map.

Several options for viewing a map and selecting an area of the map may be provided. Different map tools may provide a variety of mechanisms for manipulating the map display. For example, as shown in FIG. 9, Microsoft's MapPoint may include a field 904 in which the user may type or write a location, such as an address, building, part of town, etc. Once the location information is entered, the mapping tool may cause the map to be centered at that location. The CIM may cause that location to be displayed on devices 111, 113 etc. The location information may be retrieved from server 105 or stored locally. The map software may provide a tool 906 allowing the user to zoom in and out of the map 900. Tool 906 may include a slide bar 908 for zooming in and out of the map 801. Tool 910 may be provided to allow panning around the map 801. The view of map 801 may be moved north, south, east, and west in a known manner by selecting tool 910. Different types of information and maps may be viewed via GUI 901. Here, map 801 is a road map. A drop down menu 912 may allow other views, such as satellite views, terrain maps, and others to be displayed.

Information may be selectively shown or suppressed from the map 801. For example, map 801 also shows location of a school 922. Other buildings or features may also be selectively shown on the map 801, depending on the particular implementation and user preferences.

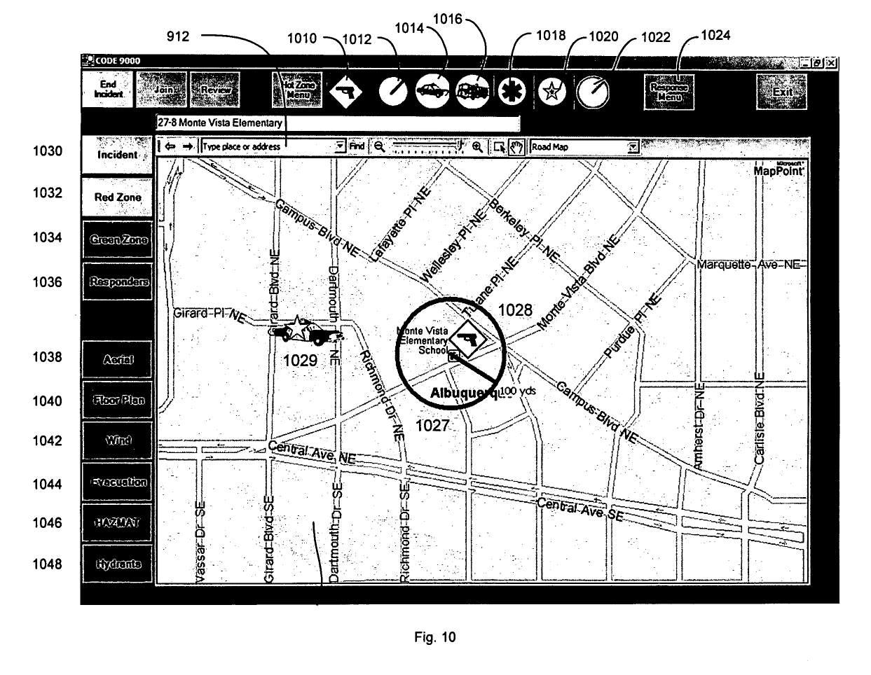

Using application programming interfaces, graphical tools may be provided for providing information about the incident. FIG. 10 illustrates, examples of graphical tools, here UI icons, that may be provided. Buttons for creating UI icons include the hot zone 1010, the inner perimeter 1012, a police unit 1014, a fire unit 1016, a medical staging area 1018, the location of the command post 1020, and an outer perimeter 1022. Other types of response units may be selected from the menu obtained by clicking the “Response Menu” 1024 button. The UI icons may be dragged and dropped onto the map 1000 at desired locations in a known manner. UI icons may be selectable and movable to indicate the locations of objects, vehicles, and individuals involved in the incident. For example, UI icon 1028 on map 1000 indicates the location of the hot zone, UI icon 1029 indicates the location of a police unit, which has been designated at the command post. Circle 1027 indicates that an inner perimeter has been established.

The color of a UI icon or its border on the map may indicate whether its associated function has been completed or is pending. In embodiments of the invention, only one officer and/or dispatcher may be allowed to make changes in an ongoing incident, so it is not possible for another responder to inadvertently change incident data while viewing the current incident status.

A set of buttons 1030-1048 may also be provided corresponding to phases typically found in managing a critical incident and additional information that may be needed. Different types and numbers of buttons may be provided depending on the particular implementation and the applicable standard operating procedures. The buttons may change from a red background to a green background when selected. By selecting one of these buttons, the user may indicate that the corresponding incident management phase is complete. For example, when an inner perimeter is established for the incident, the user may select the red zone button 1032, and the color of the red zone button 1032 may change from red to green. The steps may be performed in an order different from that indicated and described here.

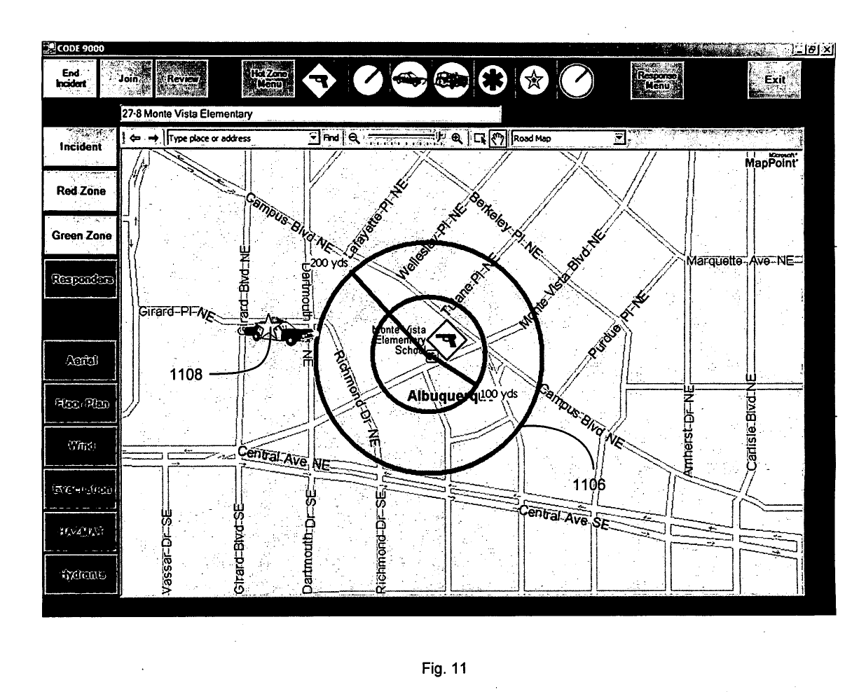

When initiated, the CIM may provide an option of starting a new incident or viewing an existing incident. Button 802 (FIG. 9) may be selected when a new incident occurs. The text of button 802, which may read “New Incident”, may change to read “End incident” when viewing an ongoing incident, (see FIG. 11). When button 802 is selected, a field 912 (FIG. 10) may be provided for the user to enter a name for the incident, such as “27-8 Monte Vista Elementary”, using an input device such as a keyboard. Unique identifying information may be sent to server 105 along with the name of the incident. The complete set of identifying data may be used to find the incident data in a global set of available incidents.

As noted above, map 1000 may be shared with others. As new information is entered into device 111, that information may communicated to server 105. Server 105 then sends updated information to other computers, devices 111, etc. that are subscribed to this incident. Thus, information regarding the incident may be generated at the incident scene and nearly instantaneously provided to multiple users at remote locations. The incident scene may be established on an ad hoc basis.

Next, in embodiments of the invention, a hot zone may be established. The hot zone may be the area around the incident that is the most dangerous. Button 1010 may be used to establish a hot zone UI icon 1028. The icon may be dragged and dropped onto map 1000 to establish the center of the hot zone. A size and shape of the hot zone may be changed using the perimeter button 1012, then dragging the hot zone outward. A size of the hot zone, such as in city blocks, area, radius, etc. may be shown as the perimeter 1027 is being established. Once the perimeter is set, the size of the hot zone may be shown next to the perimeter. The location of the hot zone may also be shown in text on the map. In the example shown in FIG. 10, a circular hot zone is shown. A perimeter of the hot zone may be displayed. Different and/or irregular shaped hot zones and/or perimeters may also be provided. The hot zone may be displayed in a color, such as red, to direct a user's attention to the hot zone. Once the hot zone is established, button 1032 may be pressed indicating completion of this phase.

Referring to FIG. 11, additional perimeters may also be designated. Different colors or other indicators may be used to differentiate the hot zone and/or the various perimeters from each other. In this example, additional perimeters such as perimeter 1106 may be created using the perimeter tools 1012, 1022 in a manner similar to that described above with respect to the hot zone. Outer perimeter 1106 has a diameter of 200 yards and may be shown in green color. Once the inner and outer perimeters are established, button 1034 may be pressed indicating completion of this task. Multiple perimeters and/or hot zones of a location view may also be provided.

The first responder's location may be set on the map. If the 1R has a vehicle location system, this may be taken care of automatically. The location system may include, but is not limited to, GPS, wireless communication location based systems, etc. The location system may provide the current location to the CIM, which creates and displays a command post UI icon 1108 at the appropriate location on the map. This may be done via the command post button 1020, which is used to drag UI icon 1108 into place on the map. The command post icon 1108 may also indicate the rank or other information regarding the command post.

CIM may also provide the ability of the user to request support. Buttons 1014-1018, and the buttons on the “Response Menu,” may be used to request additional units at the incident scene. The user may request additional units in a traditional manner via radio. As the user identifies and requests additional unit, buttons 1014-1018 may be used to drag and drop the requested units onto the map at the desired location. The appropriate icon button may be selected for, for example, police, fire, ambulance, etc. Alternatively or in addition, the user may use the map and UI icons to request the additional units. The CIM receives the user input selecting an additional unit, the unit location and the type of unit. This information may automatically be provided to dispatch 107, for example, who then sends the appropriate unit to the specified location.

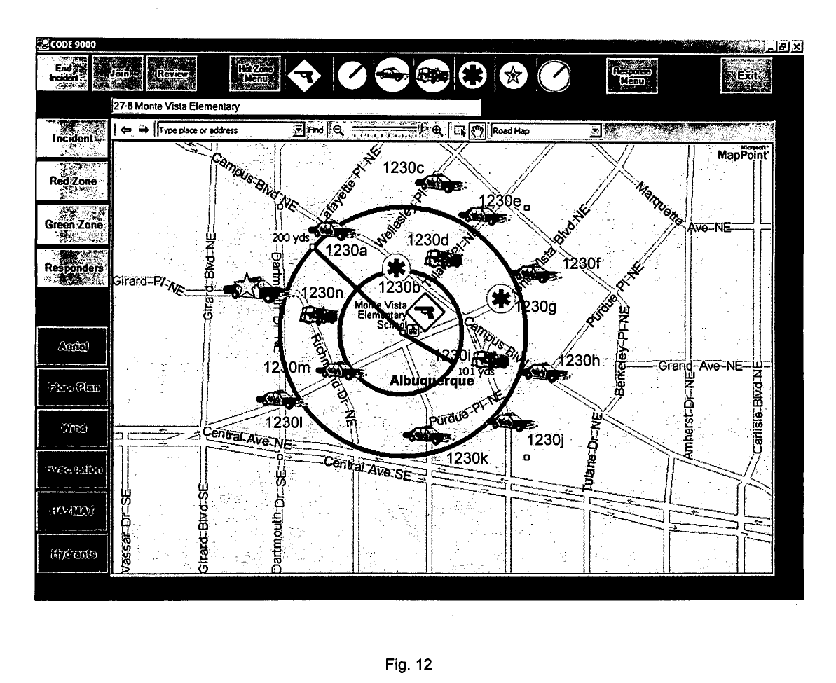

FIG. 12 shows the locations of a number of requested additional units, 1230a-1230n. Additional units that have been requested, but have not yet arrived on scene may be distinguished from those units already on scene. Once a unit arrives on scene, the UI icon may be changed to indicate the unit has arrived. The coloring may be done automatically by CIM if the units include a location system, such as GPS. Location information from the location system may be provided to the server. The server may update the incident information to indicate progress of the requested units towards the requested location, in near-real time. Manual indication of arrived units may also be supported. Once the user is notified via radio or other means that a unit is now on scene, the user may select the corresponding icon on map, for example with a single “click”, to change the UI icon. Once additional units are requested, the user may press button 1036 indicating that this step is completed.

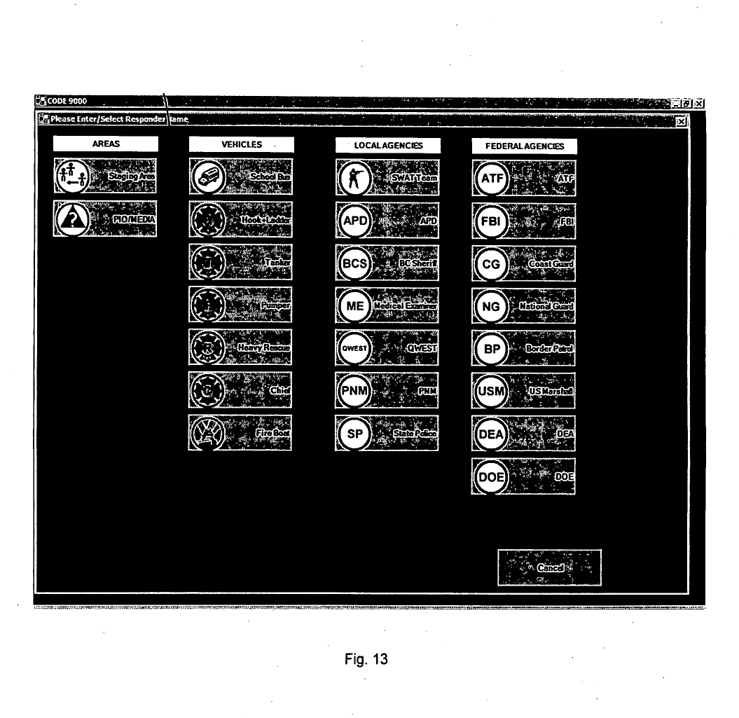

Other types of response units may also be requested. Referring to FIG. 13, an exemplary screenshot 1300 shows a variety of staging areas, vehicles, and other agencies that may be requested or may be involved in responding to the incident. The GUI shown in FIG. 13 may be accessed by clicking the “Response Menu” button shown in previous figures (for example, in FIG. 12).

Communications between various entities may be facilitated using the CIM. A user may select a UI icon and be placed in communication with the entity the UI icon represents. For example, the command post may be indicated on a map of the incident scene. A responder may select the icon for the command post and be placed in communication with the command post. Other information regarding an entity may also be available by selecting the corresponding icon. Staying with the command post example, the identity of the scene commander, rank, years experience, vehicle and available equipment, etc. may be displayed. Essentially any desired information may be made available.

The invention is described in detail with respect to preferred embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed is:

1. An emergency incident management system, comprising:
a. a remote device including data communications and location capability;
b. software modules operable on the remote device to enable a user to access a user interface (UI) including at least one electronic map of an incident location, to utilize icons to populate the at least one electronic map with operational information including a location of the incident and of one or more responders at or near the incident location and to add remote device timestamps to event data to be communicated to a server; and
c. the server disposed at a central location and adapted to receive the event data from the remote device, add server timestamps to the incoming event data, store the event data using a database system, and publish the event data by creating a web page and sending the page to a web server where it can be viewed by authorized viewers.

2. The system of claim 1 including wireless communications between the remote device being used at the scene of the incident and the server.

3. The system of claim 1 wherein the event data comprises information regarding the incident entered into the remote device by the user.

4. The system of claim 1, wherein the location capability is implemented using a Global Positioning System (GPS) receiver.

5. The system of claim 1, wherein the at least one electronic map comprises at least one of: illustrations, archived satellite photos, real-time satellite photos, images, video, georeferenced data, and/or surveillance data.

6. The system of claim 1, wherein the at least one electronic map comprises a building floor plan illustration.

7. The system of claim 1, wherein said remote device comprises at least one of: a computing device, a communications device, a handheld device, a telephony device, a laptop, a smart phone, and/or a personal digital assistant (PDA).

8. The system of claim 1, including a computer program on the remote device that enables a first responder to retrieve additional information about at least one of: UI objects placed on the map, or other georeferenced objects, by selecting an icon associated with the UI object.

9. The system of claim 1 wherein the server implements one or more access classes to control which remote devices are allowed to input event data and which remote devices allowed to retrieve existing event data.

10. The system of claim 1 wherein the server manages a plurality of separate incidents at one time.

11. The system of claim 10, wherein the server allows only those remote devices associated with a particular incident to input, modify, or retrieve event data regarding that incident.

12. The system of claim 1 further comprising a backup server in communication with the server.

13. The system of claim 11 wherein the server implements access controls allowing access rights remote devices to view or participate in incidents that the remote device is not associated with.

14. The system of claim 11, wherein the server sends incident alert messages to remote devices not associated with the incident.

15. The system of claim 1 wherein the server supports pre-planning of events.

16. The system of claim 1 wherein the server retrieves the event data to replay the incident.

17. The system of claim 1 wherein the server support incidents that have a moving location.

18. The system of claim 1 further comprising a plurality of incidents managed by the server, the incidents each having a response priority.

19. The system of claim 18, wherein the server supports setting of response priorities by an EOC.

20. The system of claim 11 wherein the server joins separate incidents into a larger incident.

21. The system of claim 11 further comprising a plurality of remote devices, wherein one remote device is designated an incident commander and is authorized to locate response units on the map, establish a command post, establish one or more perimeters, establish staging areas, and plan and manage other details associated with the incident, and to locate and move associated icons on the map.

22. The system of claim 21 wherein one remote device is designated a dispatcher and is also authorized to locate and move icons on the map.

23. The system of claim 21 wherein an emergency operations center is authorized to locate and move icons on the map.

24. The system of claim 22 wherein remote devices are assigned to other response units and are enabled to view, but not alter, the icons placed on the map by the incident commander or the dispatcher.

25. The system of claim 1 wherein the software modules are adapted for diagramming and managing the incident whether the network connection to the server is available or not.

26. The system of claim 10 wherein several classes of users are defined comprising at least one of:
a. an incident commander (often the first officer on the scene),
b. a dispatcher located at a central site,
c. an emergency operations center, and
d. other response units.

27. A Graphical User Interface (GUI), comprising:
a geographic information (GIS) system application adapted to depict a map; and
user-selectable user interface (UI) objects adapted to be graphically selected and positioned on said map by a user so as to manage an incident, the UI objects being adapted to allow a user to execute at least one of:
a. identify a secure radio channel for use by operators;
b. establish one or more staging or meeting areas at or near the area of operation;
c. establish an outer perimeter at the area of operation; or
d. identify and/or request addition resources as necessary to support the incident.
e. incident.

28. The GUI of claim 26, wherein said UI objects may comprise at least one of:
a. a responder indicator,
b. one or more perimeter indicators,
c. an object indicator,
d. a vehicle indicator,
e. a rank of the responder indicator, and/or
f. a type of responder.

29. A method of conducting emergency incident management using a portable computer including software modules operable on the portable computer to enable first responders at or near an area of operation to access at least one electronic map of an incident location, utilize icons to populate the at least one electronic map with operational information including location of a hot zone and of operators at or near the incident, the method comprising the steps of:
a. dispatching a first responder to the scene of an emergency incident;
b. a first responder operating a portable computer at or near the scene of an emergency incident to access an emergency response management program module;
c. utilizing the program module to identify the first responder as a commander at the scene having control over the incident response, identify the first responder's department affiliation and identify the emergency incident type.

30. The method of claim 29, wherein the program module is adapted to perform one or more of the following:
a. designate a channel for communication for operators at the emergency incident;
b. designate a name for the emergency incident
c. establish the type of incident;
d. establish a tactical radio channel;
e. establish a hot zone;
f. establish one or more perimeters;
g. establish staging areas.

31. The method of claim 29, wherein the at least one electronic map comprises at least one of: illustrations, archived satellite photos, real-time satellite photos.

32. The method of claim 29, wherein the at least one electronic map comprises a building floor plan illustration.

33. The method of claim 29, wherein said portable computer comprises at least one of: a laptop, a smart phone, a PDA.

34. A system of claim 29, wherein the portable computer includes a computer program that enables the first responder to retrieve additional information about a participant or landmark such as a building by selecting an icon associated with the participant or landmark.

35. A system comprising:
a plurality of remote devices including data communication capability, the remotes devices being organized in groups;
software modules operable on the remote devices to enable a user to access a user interface (UI) including at least one electronic map of an incident location and to utilize icons to populate the at least one electronic map with operational information including location of the incident and one or more responders at or near the incident location;
a plurality of servers in communication with each other, each of the groups of remote devices being associated with at least one of the servers as a primary server, the primary sever for the respective groups of remote devices being adapted to receive event data from the remote devices and publish the event data to other remote devices in the group, at least one server being adapted to monitor the event data from other servers and provide the event data to other groups of remote devices.

36. The system of claim 35 wherein the servers implements one or more access classes to control which remote devices are allowed to input event data and which remote devices allowed to retrieve existing event data.

37. The system of claim 35 wherein the servers are arranged in a hierarchy.

38. The system of claim 35 wherein the servers manages a plurality of separate incidents at one time.

39. The system of claim 35, wherein the server allows only those remote devices in the group to input, modify, or retrieve event data regarding incidents for that group.

40. The system of claim 35 further comprising a backup server in communication with the server.

41. The system of claim 35 wherein each group of remote devices is associated with a different agency.
